(19) United States
(12) Patent Application Publication
(10) Pub. No.: US 2023/0267286 A1
(43) Pub. Date: Aug. 24, 2023

(54) TRANSLATION MODEL TRAINING METHOD, TRANSLATION METHOD, APPARATUS, DEVICE, AND STORAGE MEDIUM

(71) Applicant: Beijing Baidu Netcom Science Technology Co., Ltd., Beijing (CN)

(72) Inventors: Liwen Zhang, Beijing (CN); Meng Sun, Beijing (CN); Zhongjun He, Beijing (CN); Zhi Li, Beijing (CN)

(73) Assignee: Beijing Baidu Netcom Science Technology Co., Ltd., Beijing (CN)

(21) Appl. No.: 17/879,965

(22) Filed: Aug. 3, 2022

(30) Foreign Application Priority Data
Feb. 22, 2022 (CN) 202210161027.3

(51) Int. Cl. G06F 40/58; G06F 40/211

(52) U.S. Cl. CPC G06F 40/58; G06F 40/211

(57) ABSTRACT

Provided are a translation model training method, a translation method, a device, and a storage medium, and relates to a field of computer technology, and in particular, to artificial intelligence fields such as natural language processing, machine translation and the like. The translation model training method includes: processing a sample document, to obtain an RST discourse structure tree in a dependency form of the sample document, a side in the RST discourse structure tree in the dependency form indicating an RST relationship in a discourse of the sample document; determining an attention mechanism of a translation model to be trained, based on the RST relationship in the RST discourse structure tree in the dependency form; and inputting the RST discourse structure tree in the dependency form and the sample document into the translation model to be trained for training, to obtain a trained translation model.

### CROSS-REFERENCE TO RELATED APPLICATIONS

The present application claims the priority from Chinese Patent Application No. 202210161027.3, filed with the Chinese Patent Office on Feb. 22, 2022, the content of which is hereby incorporated herein by reference in its entirety.

### TECHNICAL FIELD

The present disclosure relates to a field of computer technology, and in particular, to artificial intelligence fields such as natural language processing, machine translation and the like.

### BACKGROUND

Machine translation includes a process of translating a source language into a target language. At present, a transformer-based neural machine translation (NMT) model has achieved good translation effects in various translation tasks. However, the machine translation is normally performed with a sentence as a unit. In an actual scenario, it is often needed to translate a complete paragraph or document. The document has cohesion and coherence, and a cohesion phenomenon, such as reference, ellipsis, repetition and the like, and a semantic coherence relationship exist among sentences in the document. During translation, if the effect of the context of the document is not taken into consideration, it is difficult to produce an accurate and coherent translation.

### SUMMARY

Provided are a translation model training method, a translation method, an apparatus, a device, and a storage medium.

According to an aspect of the present disclosure, provided is a translation model training method, including: processing a sample document, to obtain an RST discourse structure tree in a dependency form of the sample document, a side in the RST discourse structure tree in the dependency form indicating an RST relationship in a discourse of the sample document; determining an attention mechanism of a translation model to be trained, based on the RST relationship in the RST discourse structure tree in the dependency form; and inputting the RST discourse structure tree in the dependency form and the sample document into the translation model to be trained for training, to obtain a trained translation model.

According to another aspect of the present disclosure, provided is a translation method, including: processing a document to be processed, to obtain an RST discourse structure tree in a dependency form of the document to be processed, a side in the RST discourse structure tree in the dependency form indicating an RST relationship in a discourse of the document to be processed; and inputting the RST discourse structure tree in the dependency form and the document to be processed into a trained translation model for performing a translation, to obtain a target document, the trained translation model being obtained by performing training using a translation model training method according to any embodiment of the present disclosure.

According to another aspect of the present disclosure, provided is a translation model training apparatus, including: a processing module configured to process a sample document, to obtain an RST discourse structure tree in a dependency form of the sample document, a side in the RST discourse structure tree in the dependency form indicating an RST relationship in a discourse of the sample document; a determining module configured to determine an attention mechanism of a translation model to be trained, based on the RST relationship in the RST discourse structure tree in the dependency form; and a training module configured to input the RST discourse structure tree in the dependency form and the sample document into the translation model to be trained for training, to obtain a trained translation model.

According to another aspect of the present disclosure, provided is a translation apparatus, including: a second processing module configured to process a document to be processed, to obtain an RST discourse structure tree in a dependency form of the document to be processed, a side in the RST discourse structure tree in the dependency form indicating an RST relationship in a discourse of the document to be processed; and a translating module configured to input the RST discourse structure tree in the dependency form and the document to be processed into a trained translation model for performing a translation, to obtain a target document, the trained translation model being obtained by performing training using a translation model training apparatus according to any embodiment of the present disclosure.

According to another aspect of the present disclosure, provided is an electronic device, including: at least one processor; and a memory communicatively connected to the at least one processor. The memory storing an instruction executable by the at least one processor, and the instruction being executed by the at least one processor to cause the at least one processor to execute a method according to any embodiment of the present disclosure.

According to another aspect of the present disclosure, provided is a non-transitory computer-readable storage medium storing a computer instruction. The computer instruction is used to cause a computer to execute a method according to any embodiment of the present disclosure.

According to another aspect of the present disclosure, provided is a computer program product, including a computer program. The computer program, when executed by a processor, executing a method according to any embodiment of the present disclosure.

Embodiments of the present disclosure can determine an attention mechanism of a translation model according to an RST relationship in a discourse of a sample document and train the translation model, so that a translation result of the translation model is more accurate.

It should be understood that, the content described in this part neither intends to identify critical or essential features of embodiments of the present disclosure nor means to limit the scope of the present disclosure. Other features of the present disclosure will become easily in understandable through the following description.

### BRIEF DESCRIPTION OF THE DRAWINGS

The accompanying drawings are used to better understand the present solution, and do not constitute a limitation to the present disclosure.

FIG. 1 is a schematic flowchart of a translation model training method according to an embodiment of the present disclosure.

FIG. 2 is a schematic flowchart of a translation model training method according to another embodiment of the present disclosure.

FIG. 3 is a schematic diagram of an example of an RST discourse structure tree.

FIG. 4 is a schematic diagram of another example of an RST discourse structure tree.

FIG. 5 is a schematic diagram of an example of the RST discourse structure tree shown in FIG. 3 in a dependency form.

FIG. 6 is a schematic diagram of an example of the RST discourse structure tree shown in FIG. 4 in a dependency form.

FIG. 7 is a schematic flowchart of a translation method according to another embodiment of the present disclosure.

FIG. 8 is a schematic flowchart of a translation method according to another embodiment of the present disclosure.

FIG. 9 is a schematic structure of a translation model training apparatus according to another embodiment of the present disclosure.

FIG. 10 is a schematic structure of a translation model training apparatus according to another embodiment of the present disclosure.

FIG. 11 is a schematic structure of a translation apparatus according to another embodiment of the present disclosure.

FIG. 12 is a schematic structure of a translation apparatus according to another embodiment of the present disclosure.

FIG. 13 is a schematic diagram of an RST discourse structure tree in an application scenario.

FIG. 14 is a schematic diagram of the RST discourse structure tree shown in FIG. 13 in a dependency form.

FIG. 15 is a schematic block diagram of an exemplary electronic device for implementing the embodiments of the present disclosure.

### DETAILED DESCRIPTION

The following describes exemplary embodiments of the present disclosure with reference to the accompanying drawings, where various details of the embodiments of the present disclosure are included to facilitate understanding, and should be considered as merely exemplary. Therefore, those having ordinary skill in the art should realize that various changes and modifications can be made to the embodiments described herein without departing from the scope and spirit of the present disclosure. Likewise, for clarity and conciseness, descriptions of well-known functions and structures are omitted in the following descriptions.

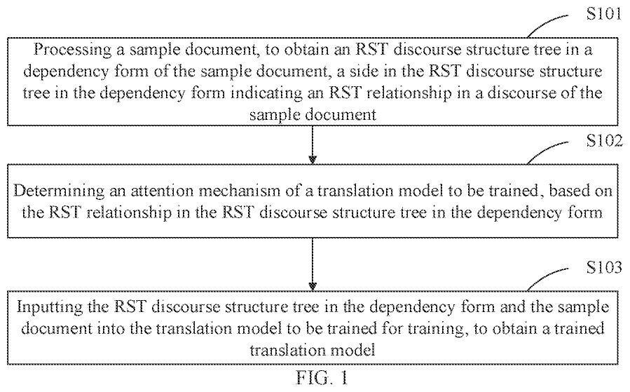

FIG. 1 is a schematic flowchart of a translation model training method according to an embodiment of the present disclosure. The method may include the followings.

In S101, a sample document is processed, to obtain a Rhetorical Structure Theory (RST) discourse structure tree in a dependency form of the sample document, a side in the RST discourse structure tree in the dependency form indicating an RST relationship in a discourse of the sample document.

In S102, an attention mechanism of a translation model to be trained is determined, based on the RST relationship in the RST discourse structure tree in the dependency form.

In S103, the RST discourse structure tree in the dependency form and the sample document are input into the translation model to be trained for training, to obtain a trained translation model.

In the embodiments of the present disclosure, the attention mechanism in the translation model to be trained and trained translation model may be determined based on the RST relationship in the RST discourse structure tree in the dependency form.

It is believed by the RST that, a document is a hierarchical structure body organized by means of relationships among respective parts, and this structure ensures coherence of the document. Each part of the document undertakes a specific task relative to other parts to accomplish a specific function. The RST relationship may also be called a rhetorical relationship and the like. All RST relationships in each discourse may constitute a hierarchical structure. Two minimum analysis units have a certain functional and semantic relationship therebetween, and this relationship may be combined with another unit to constitute a higher-level relationship. This process goes on, and finally a highest unit may connect the entire document together to form a whole. In different types/genres of documents, the number of relationship layers is not fixed, and is mainly determined by the complexity degree of semantic relationships among units in the document. Generally speaking, the more complex the semantic relationships of a document are, the more layers of RST relationships the document has. The layers of RST relationships may have homogeneity, and each layer may be described according to the function. The RST relationships may include, but are not limited to, proving, connection, elaboration, condition, motivation, evaluation, purpose, cause, summary and the like, and the specific relationship may be determined according to needs of an actual application scenario.

Based on the RST, a tree structure may be used to indicate a document including a discourse. A leaf node of a tree is called an elementary discourse unit (EDU), and indicates a minimum discourse semantic unit, i.e., the minimum analysis unit. A non-terminal node of the tree is generally constituted by two or more adjacent discourse units combined upwards. A tree obtained by dividing a document based on the RST is an RST discourse structure tree, which is also called an RST tree, an RST discourse tree, a discourse structure tree, a discourse rhetorical structure tree. The RST discourse structure tree constitutes a hierarchical structure of a document through rhetorical relationships. There are many ways to generate the RST discourse structure tree. For example, a tree structure may be generated in a top-down or bottom-up way according to relationships among sentences in the document.

The embodiments of the present disclosure can determine an attention mechanism of a translation model according to an RST relationship in a discourse of a sample document and train the translation model, so that a translation result of the translation model is more accurate. For example, the translation result has a more coherent context and a clearer logic.

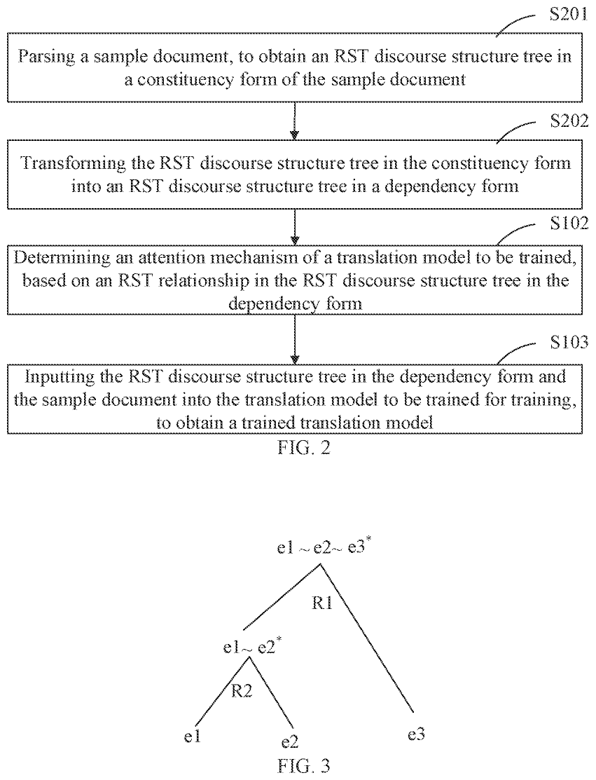

FIG. 2 is a schematic flowchart of a translation model training method according to another embodiment of the present disclosure. The method of the present embodiment includes one or more features of the above embodiment of the translation model training method. In a possible implementation, S101 of processing the sample document, to obtain the RST discourse structure tree includes the followings.

In S201, the sample document is parsed, to obtain an RST discourse structure tree in a constituency form of the sample document.

In S202, the RST discourse structure tree in the constituency form is transformed into the RST discourse structure tree in the dependency form.

In the embodiments of the present disclosure, first, the RST discourse structure tree in the constituency form may be called an RST constituency tree for short. The RST discourse structure tree in the dependency form may be called an RST dependency tree for short. After the RST constituency tree is obtained by parsing the document, the RST constituency tree may be transformed into the RST dependency tree. Therefore, an RST dependency tree of a certain document is a dependency form of the RST constituency tree of the certain document. A constituency tree may be regarded as a binary tree based on a head constituency, a nuclei being the head, and sub-nodes of each node are sorted linearly. The constituency tree may be simulated by using the dependency tree. A rhetorical relationship in the RST constituency tree is regarded as a functional relationship between two EDUs in the RST dependency tree. Each EDU may be marked as a “nuclei” or a “satellite”, which may indicate the feature of nuclei energy or significance of this ED-U. A nuclei node is generally located at a central position, and a satellite node is generally located at a peripheral position and is not very important in terms of content and grammar dependence. There are dependency relationships among EDUs, and the dependency relationships represent their rhetorical relationships.

For example, referring to FIG. 3, a document includes a plurality of elementary discourse units (EDUs): e1, e2, and e3. The superscript “*” may indicate the nuclei. A tree structure based on this document includes a root node e1˜e3, and e3 is the nuclei. Sub-nodes of the root node are respectively e1˜e2 and e3, e1˜e2 and e3 having a relationship of R1 therebetween, and e2 is the nuclei in e1˜e2. Sub-nodes of e1˜e2 are respectively e1 and e2, and e1 and e2 have a relationship of R2 therebetween. R1 and R2 respectively indicate different RST relationships.

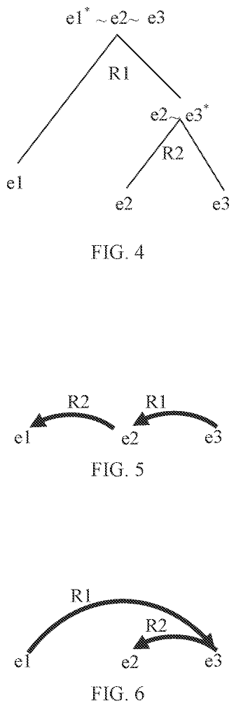

For another example, referring to FIG. 4, a document includes a plurality of EDUs: e1, e2, and e3. A tree structure based on this document includes a root node e1˜e3, and e3 is the nuclei. Sub-nodes of the root node are respectively e1 and e2˜e3, e1 and e2˜e3 having a relationship of R1 therebetween, and e3 is the nuclei in e2˜e3. Sub-nodes of e2˜e3 are respectively e2 and e3, and e2 and e3 have a relationship of R2 therebetween. R1 and R2 respectively indicate different RST relationships.

In the embodiments of the present disclosure, the RST discourse structure tree in the constituency form may be transformed into the RST discourse structure tree in the dependency form. The RST discourse structure tree in the dependency form may include a plurality of sides, and each side may indicate an RST relationship between sentences or clauses in a discourse of a document.

For example, FIG. 3 may be transformed into an RST discourse structure tree in a dependency form shown in FIG. 5. In the RST discourse structure tree in the dependency form, a side between e3 and e2 corresponds to a relationship of R1, and a side between e2 and e1 corresponds to a relationship of R2.

For another example, FIG. 4 may be transformed into an RST discourse structure tree in a dependency form shown in FIG. 6. In the RST discourse structure tree in the dependency form, a side between e1 and e3 corresponds to a relationship of R1, and a side between e3 and e2 corresponds to a relationship of R2.

In the RST discourse structure tree in the dependency form, each side may indicate an RST relationship between sentences or clauses. For example, an RST relationship matrix may be adopted to indicate an RST relationship corresponding to each side.

In the translation model, the attention mechanism may be determined based on the RST discourse structure tree in the dependency form. For example, if the translation model includes an encoder and/or a decoder, an attention mechanism in the encoder and/or the decoder is determined based on the RST discourse structure tree in the dependency form.

In the embodiments of the present disclosure, several sample documents may be used to train the translation model. In the trained translation model, values of RST relationship matrixes corresponding to various RST relationships may be determined. If a translation processing is performed on the document by using the trained translation model, the document input into the model may be transformed into a corresponding tree in the dependency form, and a value of an RST relationship matrix corresponding to each side of the tree is acquired, to further obtain a translation result with a more coherent context and a clearer logic.

In a possible implementation, the translation model adopts a transformer model. S102 of determining the attention mechanism of the translation model to be trained, based on the RST relationship in the RST discourse structure tree in the dependency form includes: obtaining an attention value, based on an RST relationship matrix corresponding to the side in the RST discourse structure tree in the dependency form, a query matrix, a key matrix, and a value matrix. In this way, by adding the RST relationship matrix corresponding to the side in the RST discourse structure tree in the dependency form into the attention mechanism, an inter-sentence relationship can be modeled by using an RST structure, and a context relevant to a sentence (or a clause) can be screened out in advance.

In a possible implementation. S102 of determining the attention mechanism of the translation model to be trained, based on the RST relationship in the RST discourse structure tree in the dependency form further includes: performing a linear transformation on a discourse representation of the sample document, to obtain the query matrix, the key matrix, and the value matrix.

In the embodiments of the present disclosure, in the attention mechanism of the transformer model, the query matrix, the key matrix, and the value matrix may be obtained by performing the linear transformation on the discourse representation of the sample document. For example, a linear transformation is performed on a discourse representation X of the sample document through the following formula 1 to respectively obtain a query matrix Q, a key matrix K, and a value matrix V:

Q=Linear_{Q}(X),K=Linearₖ(X),V=Linearᵥ(X) formula 1.

In formula 1, Linear indicates the linear transformation, and X may be the discourse representation of the document.

In the embodiments of the present disclosure, after performing the linear transformation on the discourse representation of the document to obtain the query matrix, the key matrix, and the value matrix, a new attention mechanism model may be constituted in combination with the RST relationship matrix corresponding to the side in the RST discourse structure tree in the dependency form, to further constitute a new translation model.

In the embodiments of the present disclosure, each of the query matrix, the key matrix, and the value matrix corresponding to the discourse in the document may include a plurality of vectors. For example, the query matrix Q of the document may include a plurality of query vectors Qᵢ; the key matrix K may include a plurality of key vectors Kⱼ; and the value matrix V may include a plurality of value vectors Vₗ. For example, in the document, each word has a corresponding query vector, key vector, and value vector.

In a possible implementation, S102 of determining the attention mechanism of the translation model to be trained, based on the RST relationship in the RST discourse structure tree in the dependency form further includes: determining an attention score of a word wᵢ and a word wⱼ in the sample document based on a query vector Qᵢ corresponding to the word an RST relationship matrix Rᵢⱼ between a sentence containing the word wᵢ and a sentence containing the word wⱼ, and a transposition Kⱼ^{T} of a key vector corresponding to the word wⱼ.

In the embodiments of the present disclosure, in the attention mechanism, the attention score of the words wᵢ and wⱼ in the sample document may be determined based on the query vector Qᵢ corresponding to the word wᵢ, the RST relationship matrix Rᵢⱼ between the sentence containing the word wᵢ and the sentence containing the word wⱼ, and the transposition Kⱼ^{T} of the key vector corresponding to the word wⱼ.

In the embodiments of the present disclosure, the translation model may include an encoder and/or a decoder. The encoder and/or the decoder may have a transformer structure therein, and the attention mechanism in the transformer structure may be modified based on the RST relationship matrix corresponding to the side in the RST discourse structure tree. For example, an example of a formula of the attention mechanism is as follows:

$$Attention ( Q , K , V ) = softmax ( \frac{Q {K}^{T}}{\sqrt{{d}_{k}}} ) V . \qquad formula 2$$

In formula 2, Attention(Q, K, V) indicates an attention value; softmax( ) indicates a normalization processing; Q indicates a query matrix; K indicates a key matrix; V indicates a value matrix, and dₖ indicates a dimension of a hidden layer of a translation model.

In the embodiments of the present disclosure, a portion indicating an attention score QᵢKⱼ^{T} of a word in the formula of the attention mechanism may be modified. For example, a modified formula is shown in the following formula 3:

Qᵢ·Rᵢⱼ·kⱼ^{T} formula 3.

In formula 3, Qᵢ indicates a query vector corresponding to the word wᵢ; Rᵢⱼ indicates an RST relationship matrix between the sentence containing the word wᵢ and the sentence containing the word wⱼ; and Kⱼ^{T} indicates a transposition of a key vector Kⱼ corresponding to the word wⱼ.

In the embodiments of the present disclosure, by adding an RST relationship matrix between a sentence containing one word and a sentence containing another word into an attention score of the two words, an RST relationship in an RST discourse structure can be merged into the attention score of the words, which helps to enable a translation result to have a more coherent context and a clearer logic.

Based on an attention score calculated based on the word, a modified formula of the attention mechanism may be used for indicating a formula of an attention value in S301, which can be for example the following formula 4:

$$Attention ( Q , K , V ) = softmax ( \frac{{QRK}^{T}}{\sqrt{{d}_{k}}} ) V . \qquad formula 4$$

In formula 4, Attention(Q, K, V) indicates an attention value; softmax( ) indicates a normalization processing; Q indicates a query matrix; K indicates a value matrix; V indicates a value matrix; dₖ indicates a dimension of a hidden layer of a translation model; and R indicates an RST relationship matrix between sentences. R may include a plurality of Rᵢⱼ, and a corresponding Rᵢⱼ may be found based on a sentence containing one word and a sentence containing another word.

In a possible implementation, the RST relationship matrix Rᵢⱼ between the sentence containing the word wᵢ and the sentence containing the word wⱼ includes an RST relationship matrix corresponding to a side of the sentence containing the word wᵢ and sentence containing the word wⱼ in the RST discourse structure tree in the dependency form. For example, if a side in the RST discourse structure tree in the dependency form indicates that two sentences have a proving relationship, the RST relationship matrix corresponding to the side is an RST relationship matrix of the proving relationship. If a side in the RST discourse structure tree in the dependency form indicates that two sentences have an elaboration relationship, the RST relationship matrix corresponding to the side is an RST relationship matrix of the elaboration relationship. The RST relationship matrix of the proving relationship is different from the RST relationship matrix of the elaboration relationship. For example, a value of an element included in one matrix is not completely the same as a value of an element included in another matrix. In the embodiments of the present disclosure, the RST relationship matrix corresponding to the side in the RST discourse structure tree in the dependency form may indicate the RST relationship matrix between a sentence containing one word and a sentence containing another word, so that an RST relationship in an RST discourse structure can be merged into an attention mechanism, which helps to enable a translation result to have a more coherent context and a clearer logic.

In a possible implementation, when the sentence containing the word wᵢ and the sentence containing the word wⱼ do not have a corresponding side in the RST discourse structure tree, the RST relationship matrix Rᵢⱼ between the sentence containing the word wᵢ and the sentence containing the word wⱼ is negative infinity. For example, referring to the above example, in the RST discourse structure tree in the dependency form, some sentences or clauses do not have a side therebetween. For example, S1 and S4 do not have a side therebetween. In this case, a relationship matrix Rᵢⱼ between S1 and S4 may be negative infinity. Accordingly, an attention score between a word in S1 and a word in S4 may also be negative infinity, and an attention score between sentences without an RST relationship is not taken into consideration when an attention value is calculated.

In the embodiments of the present disclosure, by setting an RST relationship matrix Rᵢⱼ between a sentence containing one word and a sentence containing another word as negative infinity, a context relationship between sentences having an RST relationship can be screened out, to obtain a more accurate attention value.

The translation model training method in the embodiments of the present disclosure may be implemented by a terminal, server, or other processing device in a single-machine, multi-machine or cluster system. The terminal may include, but is not limited to, a user device, a mobile device, a personal digital assistant, a handheld device, a computing device, a vehicle-mounted device, a wearable device and the like. The server may include, but is not limited to, an application server, a data server, a cloud server and the like.

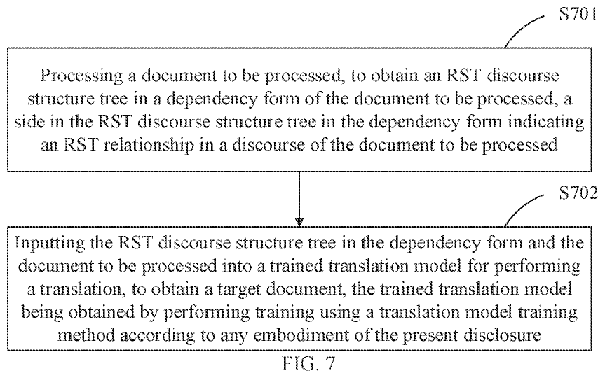

FIG. 7 is a schematic flowchart of a translation method according to another embodiment of the present disclosure. The method may include the followings.

In S701, a document to be processed is processed, to obtain an RST discourse structure tree in a dependency form of the document to be processed, a side in the RST discourse structure tree in the dependency form indicating an RST relationship in a discourse of the document to be processed.

In S702, the RST discourse structure tree in the dependency form and the document to be processed are input into a trained translation model for performing a translation, to obtain a target document.

The trained translation model is trained using a translation model training method according to any embodiment of the present disclosure.

In the embodiments of the present disclosure, an attention mechanism of the translation model may be determined based on an RST relationship in the RST discourse structure tree in the dependency form.

In the embodiments of the present disclosure, for explanations and examples of an RST discourse structure tree in a constituency form and the RST discourse structure tree in the dependency form, reference can be made to relevant descriptions of the translation model training method, and details are not repeated herein. The attention mechanism of the translation model in the embodiments of the present disclosure is determined based on the RST relationship in the discourse, so that an obtained translation result is more accurate.

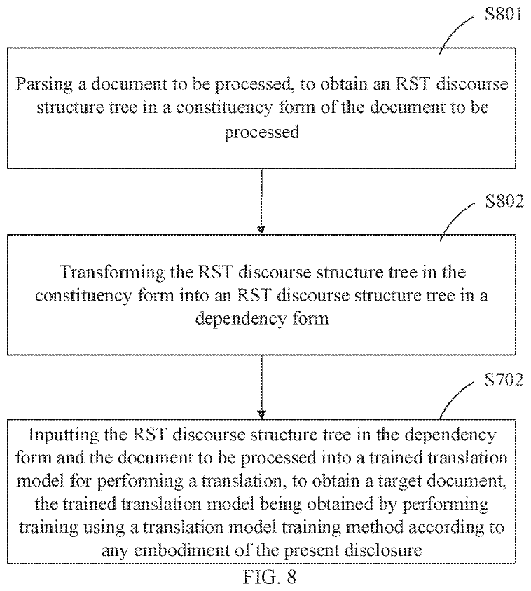

FIG. 8 is a schematic flowchart of a translation method according to another embodiment of the present disclosure. The method in the present embodiment includes one or more features of the above embodiment of the translation method. In a possible implementation, the translation method further includes the followings.

In S801, the document to be processed is parsed, to obtain an RST discourse structure tree in a constituency form of the document to be processed.

In S802, the RST discourse structure tree in the constituency form is transformed into the RST discourse structure tree in the dependency form.

In the embodiments of the present disclosure, for specific principles and examples of transforming the RST discourse structure tree in the constituency firm into the RST discourse structure tree in the dependency form, reference can be made to relevant descriptions of the embodiment of the translation model training method with reference to FIG. 3 to FIG. 6, and details are not repeated herein.

In a possible implementation, the translation model adopts a transformer model. S802 of inputting the RST discourse structure tree in the dependency form and the document to be processed into the trained translation model for performing a translation, includes: obtaining an attention value, based on an RST relationship matrix corresponding to the side in the RST discourse structure tree in the dependency form, a query matrix, a key matrix, and a value matrix. In the embodiments of the present disclosure, for the manner of modifying the attention mechanism, reference can be made to specific examples of the translation model training method, and details are not repeated herein. By adding the RST relationship matrix corresponding to the side in the RST discourse structure tree in the dependency form into the attention mechanism, an inter-sentence relationship can be modeled by using an RST structure, and a context relevant to a sentence (or a clause) can be screened out in advance.

In a possible implementation, S802 of inputting the RST discourse structure tree in the dependency form and the document to be processed into the trained translation model for performing the translation, further includes: performing a linear transformation on a discourse representation of the document to be processed, to obtain the query matrix, the key matrix, and the value matrix. In the present embodiment, for an example of the linear transformation, reference can be made to formula 1 of the translation model training method and relevant descriptions thereof, and details are not repeated herein. In the embodiments of the present disclosure, after the linear transformation is performed on the discourse representation of the document through the translation model, the query matrix, the key matrix, and the value matrix can be obtained, and a new attention mechanism model may be constituted in combination with the RST relationship matrix corresponding to the side in the RST discourse structure tree in the dependency form, to further constitute a new translation model.

In a possible implementation, S802 of inputting the RST discourse structure tree in the dependency form and the document to be processed into the trained translation model for performing the translation further includes: determining an attention score of a word wᵢ and a word wⱼ in the document to be processed based on a query vector Qᵢ corresponding to the word wᵢ, an RST relationship matrix Rᵢⱼ between a sentence containing the word wᵢ and a sentence containing the word wⱼ, and a transposition Kⱼ^{T} of a key vector corresponding to the word wⱼ. For example, an attention score is obtained by making reference to formula 3 in the above embodiment, and further an attention value is obtained based on the attention score by making reference to the above formula 4. In the embodiments of the present disclosure, by adding an RST relationship matrix between a sentence containing one word and a sentence containing another word into an attention score of the two words, an RST relationship in an RST discourse structure can be merged into the attention score of the words, which helps to enable a translation result to have a more coherent context and a clearer logic.

In a possible implementation, the RST relationship matrix Rᵢⱼ between the sentence containing the word wᵢ and the sentence containing the word wⱼ includes an RST relationship matrix corresponding to a side of the sentence containing the word wᵢ and sentence containing the word wⱼ in the RST discourse structure tree in the dependency form. In the embodiments of the present disclosure, the RST relationship matrix corresponding to the side in the RST discourse structure tree in the dependency form may indicate the RST relationship matrix between a sentence containing one word and a sentence containing another word, so that an RST relationship in an RST discourse structure is merged into an attention mechanism, which helps to enable a translation result to have a more coherent context and a clearer logic.

In a possible implementation, when the sentence containing the word wᵢ and the sentence containing the word wⱼ do not have a corresponding side in the RST discourse structure tree, the RST relationship matrix Rᵢⱼ between the sentence containing the word wᵢ and the sentence containing the word wⱼ is negative infinity. In the embodiments of the present disclosure, by setting an RST relationship matrix Rᵢⱼ between a sentence containing one word and a sentence containing another word as negative infinity, a context relationship between sentences having an RST relationship can be screened out, to obtain a more accurate attention value.

In the embodiments of the translation method of the present disclosure, terms that are the same as those in the translation model training method have the same meanings. Reference can be made to relevant descriptions of the embodiments of the translation model training method, and details are not repeated herein.

The translation model training method and/or the translation method in the embodiments of the present disclosure may be implemented by a terminal, server, or other processing device in a single-machine, multi-machine or cluster system. The terminal may include, but is not limited to, a user device, a mobile device, a personal digital assistant, a handheld device, a computing device, a vehicle-mounted device, a wearable device and the like. The server may include, but is not limited to, an application server, a data server, a cloud server and the like,

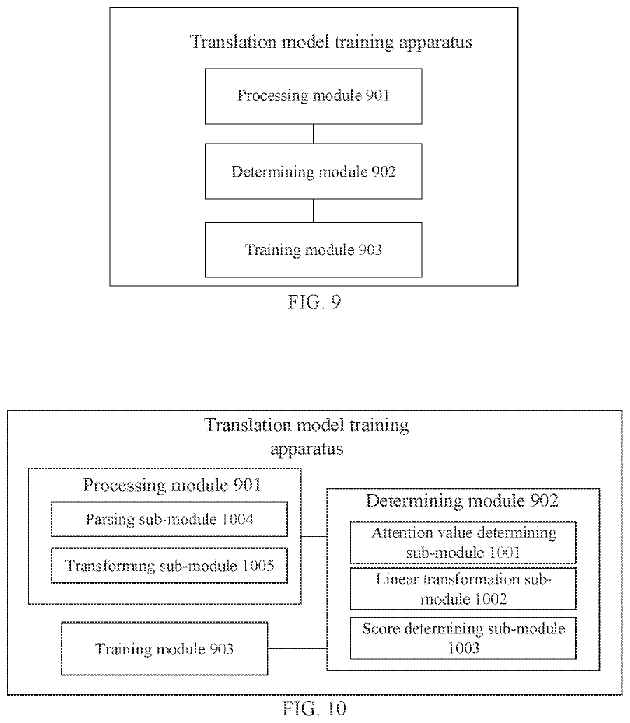

FIG. 9 is a schematic structure of a translation model training apparatus according to another embodiment of the present disclosure. The apparatus may include the followings.

A processing module 901 is configured to process a sample document, to obtain an RST discourse structure tree in a dependency form of the sample document, a side in the RST discourse structure tree in the dependency form indicating an RST relationship in a discourse of the sample document.

A determining module 902 is configured to determine an attention mechanism of a translation model to be trained, based on the RST relationship in the RST discourse structure tree in the dependency form.

A training module 903 is configured to input the RST discourse structure tree in the dependency form and the sample document into the translation model to be trained for training, to obtain a trained translation model.

FIG. 10 is a schematic structure of a translation model training apparatus according to another embodiment of the present disclosure. The apparatus in the present embodiment includes one or more features of the above embodiment of the translation model training apparatus. In a possible implementation, the translation model adopts a transformer model, and the determining module 902 includes: an attention value determining sub-module 1001 configured to obtain an attention value, based on an RST relationship matrix corresponding to the side in the RST discourse structure tree in the dependency form, a query matrix, a key matrix, and a value matrix.

In a possible implementation, the determining module 902 further includes: a linear transformation sub-module 1002 configured to perform a linear transformation on a discourse representation of the sample document, to obtain the query matrix, the key matrix, and the value matrix.

In a possible implementation, the determining module 902 further includes: a score determining sub-module 1003 configured to determine an attention score of a word wᵢ and a word wⱼ in the sample document based on a query vector Qᵢ corresponding to the word wᵢ, an RST relationship matrix Rᵢⱼ between a sentence containing the word wᵢ and a sentence containing the word wⱼ, and a transposition Kⱼ^{T} of a key vector corresponding to the word wⱼ.

In a possible implementation, the RST relationship matrix Rᵢⱼ between the sentence containing the word wᵢ and the sentence containing the word wⱼ includes an RST relationship matrix corresponding to a side of the sentence containing the word wᵢ and sentence containing the word wⱼ in the RST discourse structure tree in the dependency form.

In a possible implementation, when the sentence containing the word wᵢ and the sentence containing the word wⱼ do not have a corresponding side in the RST discourse structure tree, the RST relationship matrix Rᵢⱼ between the sentence containing the word wᵢ and the sentence containing the word wⱼ is negative infinity.

In a possible implementation, the processing module 901 includes: a parsing sub-module 1004 configured to parse the sample document, to obtain an RST discourse structure tree in a constituency form of the sample document; and a transforming sub-module 1005 configured to transform an RST discourse structure tree in the constituency form into the RST discourse structure tree in the dependency form.

For descriptions of specific functions and examples of respective modules and sub-modules of the translation model training apparatus in the embodiments of the present disclosure, reference can be made to relevant descriptions of corresponding steps in the above embodiments of the translation model training method, and details are not repeated herein.

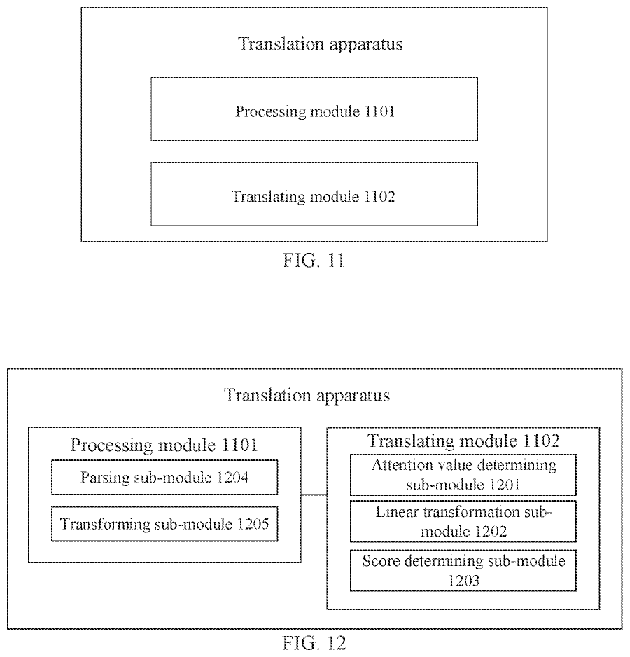

FIG. 11 is a schematic structure of a translation apparatus according to another embodiment of the present disclosure. The apparatus may include the followings.

A processing module 1101 is configured to process a document to be processed, to obtain an RST discourse structure tree in a dependency form of the document to be processed, a side in the RST discourse structure tree in the dependency form indicating an RST relationship in a discourse of the document to be processed.

A translating module 1102 is configured to input the RST discourse structure tree in the dependency form and the document to be processed into a trained translation model for performing a translation, to obtain a target document.

The trained translation model is obtained by performing training using a translation model training apparatus according to any embodiment of the present disclosure.

FIG. 12 is a schematic structure of a translation apparatus according to another embodiment of the present disclosure. The apparatus of the present embodiment includes one or more features of the above embodiment of the translation apparatus. In a possible implementation, the translation model adopts a transformer model, and the translating module 1102 includes: an attention value determining sub-module 1201 configured to obtain an attention value, based on an RST relationship matrix corresponding to the side in the RST discourse structure tree in the dependency form, a query matrix, a key matrix, and a value matrix.

In a possible implementation, the translating module 1102 further includes: a linear transformation sub-module 1202 configured to perform a linear transformation on a discourse representation of the document to be processed, to obtain the query matrix, the key matrix, and the value matrix.

In a possible implementation, the translating module 1102 further includes: a score determining sub-module 1203 configured to determine an attention score of a word wᵢ and a word wⱼ in the document to be processed based on a query vector Qᵢ corresponding to the word wᵢ, an RST relationship matrix Rᵢⱼ between a sentence containing the word wᵢ and a sentence containing the word wⱼ, and a transposition Kⱼ^{T} of a key vector corresponding to the word wⱼ.

In a possible implementation, the RST relationship matrix Rᵢⱼ between the sentence containing the word wᵢ and the sentence containing the word wⱼ includes an RST relationship matrix corresponding to a side of the sentence containing the word wᵢ and sentence containing the word wⱼ in the RST discourse structure tree in the dependency form.

In a possible implementation, when the sentence containing the word wᵢ and the sentence containing the word wⱼ do not have a corresponding side in the RST discourse structure tree, the RST relationship matrix Rᵢⱼ between the sentence containing the word wᵢ and the sentence containing the word wⱼ is negative infinity.

In a possible implementation, the processing module 1101 includes: a parsing sub-module 1204 configured to parse the document to be processed, to obtain an RST discourse structure tree in a constituency form of the document to be processed; and a transforming sub-module 1205 configured to transform the RST discourse structure tree in the constituency form into the RST discourse structure tree in the dependency form.

For descriptions of specific functions and examples of respective modules and sub-modules of the translation apparatus in the embodiments of the present disclosure, reference can be made to relevant descriptions of corresponding steps in the above embodiments of the translation method, and details are not repeated herein.

The translation model training apparatus and/or the translation apparatus in the embodiments of the present disclosure may be deployed at a terminal, server, or other processing device in a single-machine, multi-machine or cluster system. The terminal may include, but is not limited to, a user device, a mobile device, a personal digital assistant, a handheld device, a computing device, a vehicle-mounted device, a wearable device and the like. The server may include, but is not limited to, an application server, a data server, a cloud server and the like.

In related art, manners of the using of the context on a document-level machine translation (DocNMT) method mainly include: cascading and layering. The cascading includes: cascading all sentences in the context into one longer word sequence to perform coding through an attention mechanism. The layering includes: first performing an attention operation on each of sentences in the context to generate respective sentence vectors; and then performing an attention operation to the sentence vectors to generate a final semantic representation of the context. Neither of the above models of DocNMT utilizes discourse structure information.

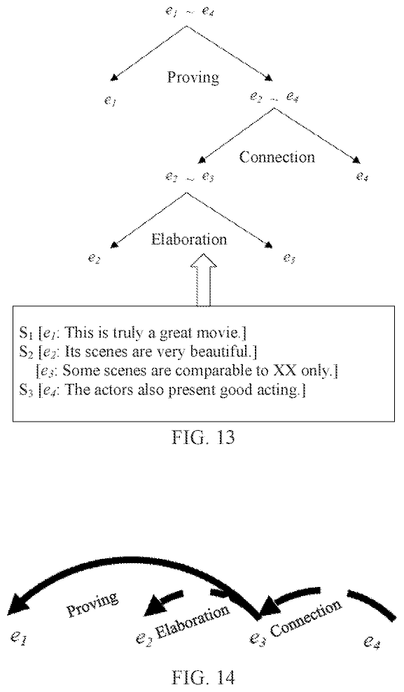

With respect to features of a transformer structure in the MIT, the solution of the embodiments of the present disclosure proposes a method of merging the discourse structure information into an attention module of the transformer model to perform the document-level machine translation (DocNMT). For example, the solution of the embodiments of the present disclosure uses the discourse structure information based on the rhetorical structure theory (RST). According to the RST, a document may be represented by a tree structure. A leaf node of a tree is called an elementary discourse unit (EDU), and is a minimum discourse semantic unit. A non-terminal node is constituted by two or more adjacent discourse units combined upwards. For example, a document includes a plurality of sentences S₁, S₂, and S₃. S₁ corresponds to [e₁: This is truly a great movie.]; S₂ corresponds to [e₂: Its scenes are very beautiful.] and [e₃: Some scenes are comparable to XX only.]; and S₃ corresponds to [e₄: The actors also present good acting.]. e₁ and e₂˜e₄ have a proving relationship therebetween, e₂˜e₃ and e₄ have a connection relationship therebetween; and e₂ and e₃ have an elaboration relationship therebetween. A root node obtained by parsing the sample document may be e₂˜e₄, which is divided into a sub-node e₁ and a sub-node e₂˜e₄; the sub-node e₂˜e₄ is further divided into a sub-node e₂˜e₃ and a sub-node e₄; and the sub-node e₂˜e₃ is further divided into a sub-node e₂ and a sub-node e₃, as shown in FIG. 13.

In the embodiments of the present disclosure, in an NMT system. RST discourse structure information may be utilized to perform the document-level machine translation. First, a document to be translated is parsed into an RST discourse structure tree, as shown in FIG. 13, by using a parser. Then, the RST discourse structure tree is transformed into an RST discourse structure tree in a dependency form. The RST discourse structure tree shown in FIG. 14 is the dependency form of FIG. 13. e₃ and e₁ have a proving relationship therebetween; e₃ and e₂ have an elaboration relationship therebetween; and e₄ and e₃ have a connection relationship therebetween.

In the embodiments of the present disclosure, the attention module in the transformer structure may be modified. For example, in the transformer structure of the translation model, an example of an original formula of the attention mechanism may be:

$$Attention ( Q , K , V ) = softmax ( \frac{Q {K}^{T}}{\sqrt{{d}_{k}}} ) V .$$

Attention(Q, K, V) indicates an attention value; softmax( ) indicates a normalization processing; a query matrix Q, a key matrix K, and a value matrix V may be obtained by performing a linear transformation of the following formula on a representation matrix, i.e., representation X, corresponding to a discourse in a document input:

Q=Linear_{Q}(X),K=Linearₖ(X)V=Linearᵥ(X).

A formula for calculating an attention score Qᵢ Kⱼ^{T} between a word wᵢ and a word wⱼ in the attention mechanism may be modified into the following formula:

Qᵢ·Rᵢⱼ·Kⱼ^{T}.

Rᵢⱼ indicates a representation of a side between the word wᵢ and a word wⱼ. Rᵢⱼ is a matrix and determined based on sentences respectively containing the words. If a sentence containing the word wᵢ and a sentence containing the word wⱼ do not have a side of an RST tree therebetween, Rᵢⱼ may be a matrix of negative infinity.

A modified example of the attention mechanism may be as follows:

$$Attention ( Q , K , V ) = softmax ( \frac{{QRK}^{T}}{\sqrt{{d}_{k}}} ) V .$$

R may include a plurality of Rᵢⱼ, and a corresponding Rᵢⱼ may be found based on the sentence containing the word wᵢ and the sentence containing the word wⱼ.

A relationship of a side between sentences not only exists at an original language end, and the same relationship also exists at a target language end. Therefore, an RST tree structure obtained by performing parsing at the original language end may also be used at a decoding end.

For a translation of a target sentence, there are few truly useful contexts. In the embodiments of the present disclosure, an RST structure is used to model an inter-sentence relationship, so that a context relevant to the current sentence can be screened out in advance.

Based on the RST, types of the inter-sentence relationship may be modeled, and additional information of the inter-sentence relationship may be provided.

Since an original language and a target language have the same sentence meaning, the original language and the target language have the same inter-sentence relationship. Therefore, the target language end may also use the same RST tree to perform modeling.

By combining an NMT model and an RST discourse structure, the translation of the whole document can be implemented, and a translation result can have a coherent context and a clear logic.

In a training process of the NMT model, an attention mechanism of the NMT model to be trained may adopt the above modified formula of the attention mechanism. In the training process, it is needed to parse a sample document to be trained into an RST discourse structure tree as shown in FIG. 13 and then transform the RST discourse structure tree into an RST discourse structure tree in a dependency form as shown in FIG. 14. Then, the RST discourse structure tree in the dependency form and the sample document are input into the NMT model to be trained for training, to determine a value of an element in an RST relationship matrix corresponding to each type of side in the RST discourse structure tree in the dependency form.

In the technical solution of the present disclosure, the involved acquiring, storing, and applying and the like of personal information of a user all conform to provisions of relevant laws and regulations, and do not go against the public order and good morals.

According to the embodiments of the present disclosure, the present disclosure also provides an electronic device, a readable storage medium and a computer program product.

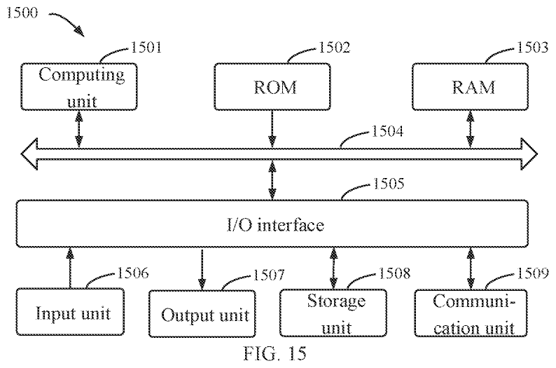

FIG. 15 shows a schematic block diagram of an exemplary electronic device 1500 for implementing the embodiments of the present disclosure. The electronic device is intended to represent various forms of digital computers, such as a laptop, a desktop, a workstation, a personal digital assistant, a server, a blade server, a mainframe, and other appropriate computers. The electronic device may also represent various forms of mobile devices, such as a personal digital assistant, a cellular telephone, a smart phone, a wearable device, and other similar computing devices. The components shown herein, their connections and relationships, and their functions, are meant to be exemplary only, and are not meant to limit implementations of the disclosure described and/or claimed in this document.

As shown in FIG. 15, the device 1500 includes a computing unit 1501, which may execute various suitable actions and processes according to a computer program stored in a read-only memory (ROM) 1502 or a computer program loaded from a storage unit 1508 to a random access memory (RAM) 1503. The RAM 1503 may also store various programs and data required for operations of the device 1500. The computing unit 1501, the ROM 1502, and the RAM 1503 are connected to each other via a bus 1504. An input/output (I/O) interface 1505 is also connected to the bus 1504.

A plurality of components in the device 1500 are connected to the I/O interface 1505, and include: an input unit 1506, such as a keyboard, a mouse and the like; an output unit 1507, such as various types of displayer, loudspeaker and the like; a storage unit 1508, such as a disk, a disc and the like; and a communication unit 1509, such as a network card, a modern, a wireless communication transceiver and the like. The communication unit 1509 allows the device 1500 to exchange information/data with other devices via a computer network, such as the Internet, and/or various telecommunication networks.

The computing unit 1501 may be various general-purpose and/or special-purpose processing components with processing and computing capabilities. Some examples of the computing unit 1501 include, but are not limited to, a central processor unit (CPU), a graphics processing unit (GPU), various special-purpose artificial intelligence (AI) computing chips, various computing units for running a machine learning model algorithm, a digital signal processor (DSP), and various suitable processors, controllers, microcontrollers and the like. The computing unit 1501 executes various methods and processing described hereinabove, for example, the translation model training method or the translation method. For example, in some implementations, the translation model training method or the translation method may be implemented as a computer software program which is tangibly included in a machine-readable medium, such as the storage unit 1508. In some implementations, part or all of the computer program may be loaded into and/or installed onto the device 1500 via the ROM 1502 and/or the communication unit 1509. When the computer program is loaded into the RAM 1503 and is executed by the computing unit 1501, one or more steps of the translation model training method or the translation method described hereinabove may be implemented. Alternatively, in other implementations, the computing unit 1501 may be configured to execute the translation model training method or the translation method by other suitable manners (for example, by means of hardware).

Various implementations of the systems and technologies described hereinabove may be implemented in a digital electronic circuit system, an integrated circuit system, a field programmable gate array (FPGA), an application-specific integrated circuit (ASIC), an application-specific standard parts (ASSP), a System on Chip (SOC), a complex programmable logic device (CPLD), computer hardware, firmware, software, and/or combinations thereof. These various implementations may include being implemented in one or more computer programs which may be performed and/or interpreted on a programmable system including at least one programmable processor, and the programmable processor may be a special-purpose or general-purpose programmable processor, may receive data and instructions from a storage system, at least one input device, and at least one output device, and transmit the data and instructions to the storage system, the at least one input device, and the at least one output device.

The program code for implementing the method of the present disclosure can be written with one programming language or any combination of multiple programming languages. The program code may be provided to a processor or controller of a general-purpose computer, a special-purpose computer, or other programmable data processing apparatuses, so that the program code, when executed by the processor or the controller, enables functions/operations provided in the flowchart and/or block diagrams to be implemented. The program code may be executed on a machine wholly or partly, and be partly executed on the machine and partly executed on a remote machine as an independent software package or be wholly executed on a remote machine or server.

In the context of the present disclosure, the machine-readable medium may be a tangible medium, and may include or store a program for use by an instruction execution system, apparatus or device or used in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing content. A more specific example of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing content.

In order to provide interaction with the user, the systems and technologies described herein can be implemented on a computer that has: a display apparatus for displaying information to the user (e.g., a cathode ray tube (CRT) or a liquid crystal display (LCD) monitor)); and a keyboard and a pointing apparatus (e.g., a mouse or a trackball) through which the user can provide input to the computer. Other types of apparatuses may also be used to provide interaction with the user. For example, feedback provided to the user can be any form of sensory feedback (e.g., visual feedback, auditory feedback, or tactile feedback); and it is capable of receiving input from the user in any form (including acoustic input, voice input, or tactile input).

The systems and technologies described herein can be implemented in a computing system that includes back-end components (e.g., as a data server), a computing system that includes middleware components (e.g., as an application server), a computing system that includes front-end components (e.g., as a user computer with a graphical user interface or web browser through which the user can interact with the implementation of the systems and technologies described herein), or a computing system that includes any combination of the back-end components, middleware components, or front-end components. The components of the system can be connected to each other through any form of digital data communication (e.g., a communication network) or digital data communication of any medium. Examples of the communication network include a local area network (LAN), a wide area network (WAN), and the Internet.

A computer system may include a client and a server. The client and server are generally far away from each other and usually interact through a communication network. The relationship between the client and the server is generated through computer programs performed on a corresponding computer and having a client-server relationship with each other. The server can be a cloud server, and can also be, a server of a distributed system, or a server combined with a blockchain.

It should be understood that various forms of processes shown above can be used to reorder, add or delete steps. For example, steps described in the present disclosure can be executed in parallel, sequentially, or in a different order, as long as the desired result of the technical solution disclosed in the present disclosure can be achieved, and this is not limited herein.

The foregoing specific implementations do not constitute a limitation on the protection scope of the present disclosure. Those having ordinary skill in the art should understand that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A translation model training method, comprising:
processing a sample document, to obtain an RST discourse structure tree in a dependency form of the sample document, a side in the RST discourse structure tree in the dependency form indicating an RST relationship in a discourse of the sample document;
determining an attention mechanism of a translation model to be trained, based on the RST relationship in the RST discourse structure tree in the dependency form; and
inputting the RST discourse structure tree in the dependency form and the sample document into the translation model to be trained for training, to obtain a trained translation model.

2. The method of claim 1, wherein the translation model adopts a transformer model, and determining the attention mechanism of the translation model to be trained, based on the RST relationship in the RST discourse structure tree in the dependency form, comprises:
obtaining an attention value, based on an RST relationship matrix corresponding to the side in the RST discourse structure tree in the dependency form, a query matrix, a key matrix, and a value matrix.

3. The method of claim 2, wherein determining the attention mechanism of the translation model to be trained, based on the RST relationship in the RST discourse structure tree in the dependency form, further comprises:
performing a linear transformation on a discourse representation of the sample document, to obtain the query matrix, the key matrix, and the value matrix.

4. The method of claim 2, wherein determining the attention mechanism of the translation model to be trained, based on the RST relationship in the RST discourse structure tree in the dependency form, further comprises:
determining an attention score of a word wᵢ and a word wⱼ in the sample document based on a query vector Qᵢ corresponding to the word wᵢ, an RST relationship matrix Rᵢⱼ between a sentence containing the word wᵢ and a sentence containing the word wⱼ, and a transposition Kⱼ^{T} of a key vector corresponding to the word wⱼ.

5. The method of claim 3, wherein determining the attention mechanism of the translation model to be trained, based on the RST relationship in the RST discourse structure tree in the dependency form, further comprises:
determining an attention score of a word wᵢ and a word wⱼ in the sample document based on a query vector Qᵢ corresponding to the word wᵢ, an RST relationship matrix Rᵢⱼ between a sentence containing the word wᵢ and a sentence containing the word wⱼ, and a transposition Kⱼ^{T} of a key vector corresponding to the word wⱼ.

6. The method of claim 4, wherein the RST relationship matrix Rᵢⱼ between the sentence containing the word wᵢ and the sentence containing the word wⱼ comprises an RST relationship matrix corresponding to a side of the sentence containing the word wᵢ and sentence containing the word wⱼ in the RST discourse structure tree in the dependency form.

7. The method of claim 5, wherein the RST relationship matrix Rᵢⱼ between the sentence containing the word wᵢ and the sentence containing the word wⱼ comprises an RST relationship matrix corresponding to a side of the sentence containing the word wᵢ and sentence containing the word wⱼ in the RST discourse structure tree in the dependency form.

8. The method of claim 4, wherein in a case of the sentence containing the word wᵢ and the sentence containing the word wⱼ do not have a corresponding side in the RST discourse structure tree, the RST relationship matrix Rᵢⱼ between the sentence containing the word wᵢ and the sentence containing the word wⱼ is negative infinity.

9. The method of claim 5, wherein in a case of the sentence containing the word wᵢ and the sentence containing the word wⱼ do not have a corresponding side in the RST discourse structure tree, the RST relationship matrix Rᵢⱼ between the sentence containing the word wᵢ and the sentence containing the word wⱼ is negative infinity.

10. The method of claim 6, wherein in a case of the sentence containing the word wᵢ and the sentence containing the word wⱼ do not have a corresponding side in the RST discourse structure tree, the RST relationship matrix Tᵢⱼ between the sentence containing the word wᵢ and the sentence containing the word wⱼ is negative infinity.

11. The method of claim 7, wherein in a case of the sentence containing the word wᵢ and the sentence containing the word wⱼ do not have a corresponding side in the RST discourse structure tree, the RST relationship matrix Rᵢⱼ between the sentence containing the word wᵢ and the sentence containing the word wⱼ is negative infinity.

12. The method of claim 1, wherein processing the sample document, to obtain the RST discourse structure tree, comprises:
parsing the sample document, to obtain an RST discourse structure tree in a constituency form of the sample document; and
transforming the RST discourse structure tree in the constituency form into the RST discourse structure tree in the dependency form.

13. A translation method, comprising:
processing a document to be processed, to obtain an RST discourse structure tree in a dependency form of the document to be processed, a side in the RST discourse structure tree in the dependency form indicating an RST relationship in a discourse of the document to be processed; and
inputting the RST discourse structure tree in the dependency form and the document to be processed into a trained translation model for performing a translation, to obtain a target document;
wherein the trained translation model is obtained by performing training using the translation model training method of claim 1.

14. An electronic device, comprising:
at least one processor; and
a memory communicatively connected to the at least one processor,
wherein the memory stores an instruction executable by the at least one processor, and the instruction is executed by the at least one processor to cause the at least one processor to execute:
processing a sample document, to obtain an RST discourse structure tree in a dependency form of the sample document, a side in the RST discourse structure tree in the dependency form indicating an RST relationship in a discourse of the sample document;
determining an attention mechanism of a translation model to be trained, based on the RST relationship in the RST discourse structure tree in the dependency form; and
inputting the RST discourse structure tree in the dependency form and the sample document into the translation model to be trained for training, to obtain a trained translation model.

15. The electronic device of claim 14, wherein the translation model adopts a transformer model, and
the instruction is executed by the at east one processor to cause the at least one processor to execute:
obtaining an attention value, based on an RST relationship matrix corresponding to the side in the RST discourse structure tree in the dependency form, a query matrix, a key matrix, and a value matrix.

16. The electronic device of claim 15, wherein the instruction is executed by the at least one processor to cause the at least one processor to execute:
performing a linear transformation on a discourse representation of the sample document, to obtain the query matrix, the key matrix, and the value matrix.

17. The electronic device of claim 15, wherein the instruction is executed by the at least one processor to cause the at least one processor to execute:
determining an attention score of a word wᵢ and a word wⱼ in the sample document based on a query vector Qᵢ corresponding to the word wᵢ, an RST relationship matrix Rᵢⱼ between a sentence containing the word wᵢ and a sentence containing the word wⱼ, and a transposition Kⱼ^{T} of a key vector corresponding to the word wⱼ.

18. An electronic device, comprising:
at least one processor; and
a memory communicatively connected to the at least one processor,
wherein the memory stores an instruction executable by the at least one processor, and the instruction is executed by the at least one processor to cause the at least one processor to execute the method of claim 13.

19. A non-transitory computer-readable storage medium storing a computer instruction, wherein the computer instruction is used to cause a computer to execute:
processing a sample document, to obtain an RST discourse structure tree in a dependency form of the sample document, a side in the RST discourse structure tree in the dependency form indicating an RST relationship in a discourse of the sample document;
determining an attention mechanism of a translation model to be trained, based on the RST relationship in the RST discourse structure tree in the dependency form; and
inputting the RST discourse structure tree in the dependency form and the sample document into the translation model to be trained fir training, to obtain a trained translation model.

20. A non-transitory computer-readable storage medium storing a computer instruction, wherein the computer instruction is used to cause a computer to execute the method of claim 13.
